(19) United States
(12) Patent Application Publication
(10) Pub. No.: US 2021/0208474 A1
(43) Pub. Date: Jul. 8, 2021

(54) CONTROL DEVICE, IMAGING DEVICE, INFORMATION PROCESSING DEVICE, AND CONTROL METHOD

(71) Applicant: Sony Corporation, Tokyo (JP)

(72) Inventors: Kazuhide YOKOTA, Tokyo (JP); Yuki ENDO, Tokyo (JP); Shinsuke TODA, Tokyo (JP); Kazuhiro NISHIDA, Tokyo (JP)

(73) Assignee: Sony Corporation, Tokyo (JP)

(21) Appl. No.: 17/056,768

(22) PCT Filed: Sep. 21, 2018
(86) PCT No.: PCT/JP2018/035228

§ 371 Date: Nov. 19, 2020

(51) Int. Cl. G03B 3/10; G03B 13/36; H04N 5/232

(52) U.S. Cl. CPC G03B 3/10; H04N 5/232121; H04N 5/232123; G03B 13/36

(57) ABSTRACT

To make it possible to adjust the focus of an imaging device more appropriately.

To provide a control device, including an acquisition unit that acquires posture information that is information related to a first posture of an imaging device, and a focus adjustment unit that adjusts a focus of the imaging device by controlling drive of an optical member on a basis of the posture information.

### FIELD

The present disclosure relates to a control device, an imaging device, an information processing device, and a control method.

### BACKGROUND

Imaging devices that generate an imaging signal by imaging a subject using an autofocus function are in widespread use. With miniaturization of imaging elements and optical members, portable information processing devices equipped with those imaging devices (camera module) are in widespread use. These portable information processing devices are equipped with an actuator for moving an optical member (focus lens) in the optical axis direction in order to realize an autofocus function.

For example, Patent Literature 1 below discloses a technique in which, by moving the focus lens by a skip operation, a reverse scan operation, and a final adjustment operation, a focus lens can be moved to a scan target position (target point) only by moving the focus lens in a direction opposite to the scan operation. This allows the time required for focus control to be shortened, and the focusing accuracy to be improved.

### CITATION LIST

### Patent Literature

Patent Literature 1: Japanese Laid-open Patent Publication No. 2012-98510

### SUMMARY

### Technical Problem

However, according to the technique disclosed in Patent Literature 1 and the like, it has sometimes been difficult to appropriately adjust the focus of an imaging device. More specifically, in a case where the posture of an imaging device is a posture oriented not horizontally but, for example, vertically upwards or vertically downwards, an optical member such as a focus lens is displaced vertically downwards from the designated position by the influence of gravity, whereby it has sometimes been difficult to appropriately adjust the focus of an imaging device.

The present disclosure has been made in view of the above circumstance, and provides a new, improved control device, an imaging device, an information processing device, and a control method that are capable of more appropriately adjusting the focus of the imaging device.

### Solution to Problem

According to the present disclosure, a control device is provided that includes: an acquisition unit that acquires posture information that is information related to a first posture of an imaging device; and a focus adjustment unit that adjusts a focus of the imaging device by controlling drive of an optical member on a basis of the posture information.

Moreover, according to the present disclosure, an imaging device is provided that includes: an optical member that takes in light from a subject; an imaging unit that generates an imaging signal by light incident through the optical member; and a drive control unit that controls drive of the optical member on a basis of control information generated for adjusting a focus on a basis of posture information that is information related to a first posture of an imaging device.

Moreover, according to the present disclosure, an information processing device is provided that includes: a control device and an imaging device, wherein the control device includes: an acquisition unit that acquires posture information that is information related to a first posture of the imaging device, and a focus adjustment unit that adjusts a focus of the imaging device by generating control information that controls drive of an optical member on a basis of the posture information, and the imaging device includes: the optical member that takes in light from a subject, an imaging unit that generates an imaging signal by light incident through the optical member, and a drive control unit that controls drive of the optical member on a basis of the control information.

Moreover, according to the present disclosure, a control method executed by a computer is provided that includes: acquiring posture information that is information related to a first posture of an imaging device; and adjusting a focus of the imaging device by controlling drive of an optical member on a basis of the posture information.

### BRIEF DESCRIPTION OF DRAWINGS

FIG. 1 is a diagram illustrating how the position of an optical member (focus lens or the like) changes depending on the posture of an imaging device.

FIG. 2 is a diagram illustrating that contact occurs due to the position of the optical member (focus lens or the like) changing depending on the posture of the imaging device.

FIG. 3 is a diagram illustrating that contact occurs due to the position of the optical member (focus lens or the like) changing depending on the posture of the imaging device.

FIG. 4 is a diagram illustrating that an optical member 130 is appropriately driven due to a control value being corrected according to the present disclosure.

FIG. 5 is a block diagram illustrating a functional configuration example of each device according to the present embodiment.

FIG. 6 is a flowchart illustrating a flow of processing by each device according to the present embodiment.

FIG. 7 is a flowchart illustrating a flow of processing by each device according to a first variation.

FIG. 8 is a view illustrating an outline of a hardware configuration example of an imaging device 100 according to the present embodiment.

FIG. 9 is a view illustrating an outline of a shape of the imaging device 100 according to the present embodiment.

FIG. 10 is a block diagram illustrating a functional configuration example of an information processing device 300 according to the present embodiment.

FIG. 11 is a block diagram illustrating a hardware configuration example of the information processing device 300 according to the present embodiment.

### DESCRIPTION OF EMBODIMENTS

Preferred embodiments of the present disclosure will be described in detail below with reference to the accompanying drawings. It is to be noted that in the present description and drawings, components having substantially identical functional configuration are given the identical reference numerals, thereby omitting redundant description thereof.

It is to be noted that the description will be given in the following order.

1. Outline

2. Functional Configuration

3. Flow of Processing

4. First Variation

5. Second Variation

6. Hardware Configuration

7. Application to Information Processing Device 300

8. Summary

<1. Outline>

First, an outline according to an embodiment of the present disclosure will be described.

As described above, while imaging devices that generate an imaging signal by imaging a subject using an autofocus function are in widespread use, according to the technique disclosed in Patent Literature 1 and the like, it has sometimes been difficult to appropriately adjust the focus of an imaging device.

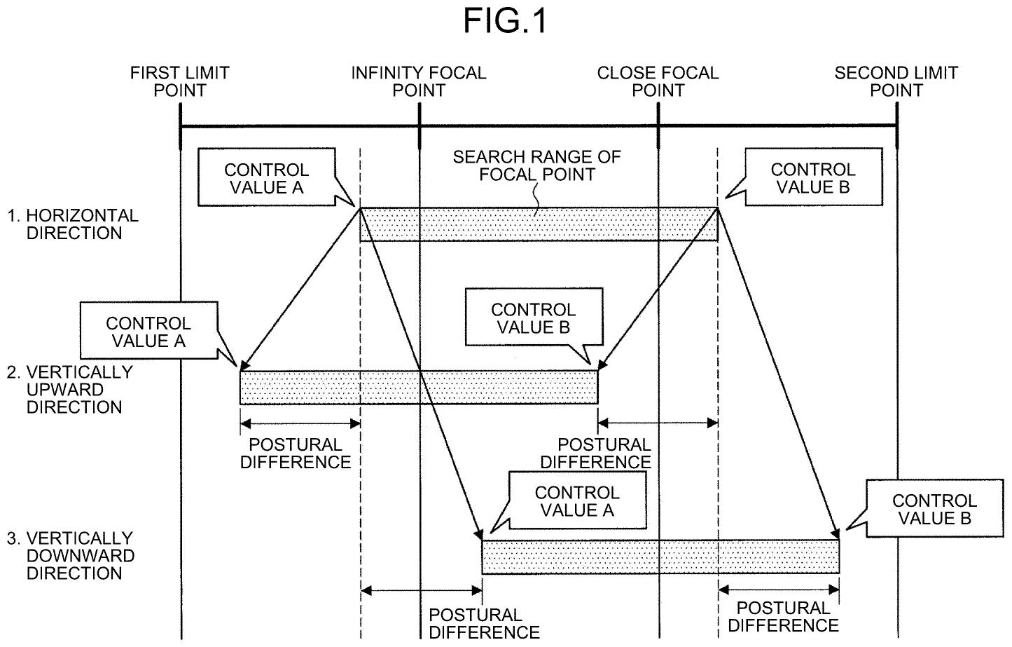

A more specific description will be given with reference to FIG. 1. It is to be noted that the following description exemplifies a case where autofocus is performed by so-called “open loop control”, which is to judge whether or not an input has reached a predetermined target value without giving feedback (It should be noted that it is not necessarily limited to open loop control).

FIG. 1 is a diagram illustrating how the position of an optical member (focus lens or the like) changes depending on the posture of an imaging device. FIG. 1 illustrates a range (written as “search range of focal point” in FIG. 1) in which the optical member is driven to search a focal point (position of the optical member at which focusing is realized) in order to realize the autofocus function for each of the cases where the imaging device is oriented horizontally, vertically upwards, and vertically downwards. In the case where the imaging device is oriented horizontally, as illustrated in “1. Horizontal direction” of FIG. 1, the imaging device has, as a search range of focal point, a range including the position of the optical member when infinity comes into focus (hereinafter referred to as “infinity focal point”) and the position of the optical member when a close range comes into focus (hereinafter referred to as “close focal point”). That is, the imaging device searches a peak of equal to or greater than a predetermined value for a contrast value while driving the optical member (focus lens or the like) in a range including from an infinity focal point to a close focal point, and treats, as a focal point, a point where the peak of equal to or greater than the predetermined value for the contrast value is detected. At this time, as illustrated in “1. Horizontal direction” of FIG. 1, it is assumed that the imaging device can move the optical member to the lower limit of the search range of the focal point by designating a control value “A” as control information, and can move the optical member to the upper limit of the search range of the focal point by designating a control value “B”.

Here, when the imaging device is oriented vertically upwards, as illustrated in “2. Vertically Upward Direction” of FIG. 1, the search range of the focal point when the control values “A” and “B” are designated as the control information is displaced to the infinity focal point side due to the weight of the optical member or the like. In this document, this “displacement” is referred to as a “postural difference”. There is a case where due to occurrence of a postural difference, the imaging device fails to drive the optical member to the close focal point even if the contrast value reaches a peak at the close focal point, for example. Hence, it may be impossible to appropriately adjust the focus.

In addition, when the imaging device is oriented vertically downwards, as illustrated in “3. Vertically Downward Direction” of FIG. 1, the search range of the focal point when the control values “A” and “B” are designated as the control information is displaced to the close focal point side due to the weight of the optical member or the like (i.e., a postural difference occurs). There is a case where due to occurrence of a postural difference, the imaging device fails to drive the optical member to the infinity focal point even if the contrast value reaches a peak at the infinity focal point, for example. Hence, it may be impossible to appropriately adjust the focus.

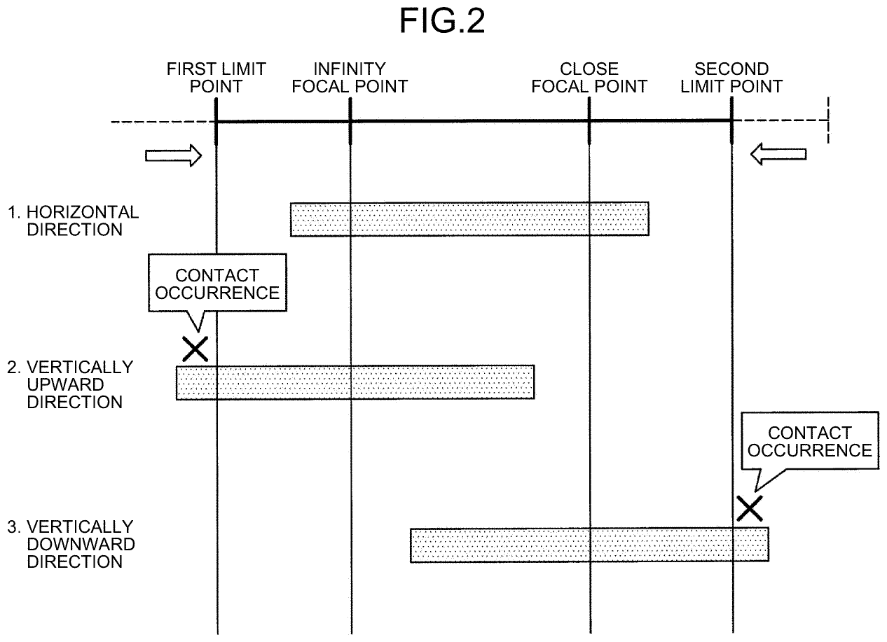

In addition, particularly in recent years, with the demand for miniaturization of the imaging device, the range in which the optical member can be driven tends to be narrower than ever. Here, of limit points of the range in which the optical member can be driven, the limit point in one direction (direction on the infinity focal point side) in which the optical member can be driven is defined as a “first limit point” and the limit point in the direction (direction on the close focal point side) opposite to the one direction is defined as a “second limit point”. At this time, with the demand for miniaturization of the imaging device, as illustrated in FIG. 2, in particular, the separation distance between the first limit point and the infinity focal point and the separation distance between the second limit point and the close focal point sometimes tend to become shorter. In this case, as illustrated in “2. Vertically Upward Direction” of FIG. 2, when a postural difference occurs due to the search range of focal point being displaced to the infinity focal point side, the optical member may come into contact with a member at the first limit point. In addition, as illustrated in “3. Vertically Downward Direction” of FIG. 2, when a postural difference occurs due to the search range of focal point being displaced to the close focal point side, the optical member may come into contact with a member at the second limit point. Such contact can cause contact noise to occur (contact noise to be recorded if video recording is being performed) and cause each member to be damaged.

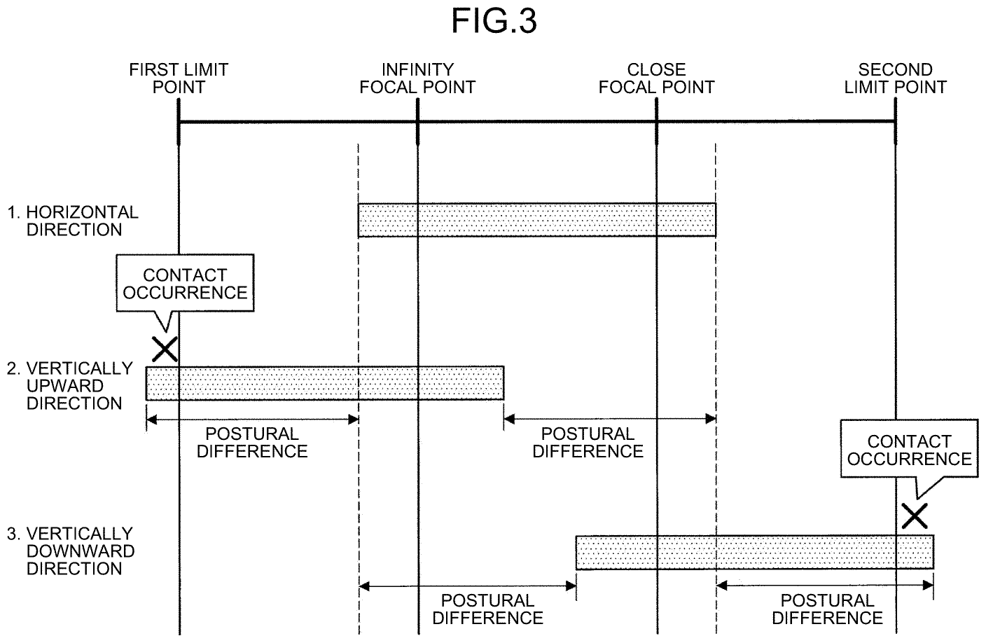

Even if the separation distance between the first limit point and the infinity focal point and the separation distance between the second limit point and the close focal point do not become short, if the optical member is heavier or the spring supporting the optical member is weaker, as illustrated in “2. Vertically Upward Direction” and “3. Vertically Downward Direction” of FIG. 3, the postural difference becomes larger, and hence contact between the members may occur also in this case.

In view of the above circumstances, the discloser of the present case has come to create the technique according to the present disclosure. The present disclosure adjusts the focus of the imaging device 100 by acquiring posture information which is information related to a first posture of the imaging device 100 and controlling the drive of the optical member 130 on the basis of the posture information. Here, the “first posture” refers to a posture of the imaging device 100 at the time point when focus adjustment of the imaging device 100 is performed.

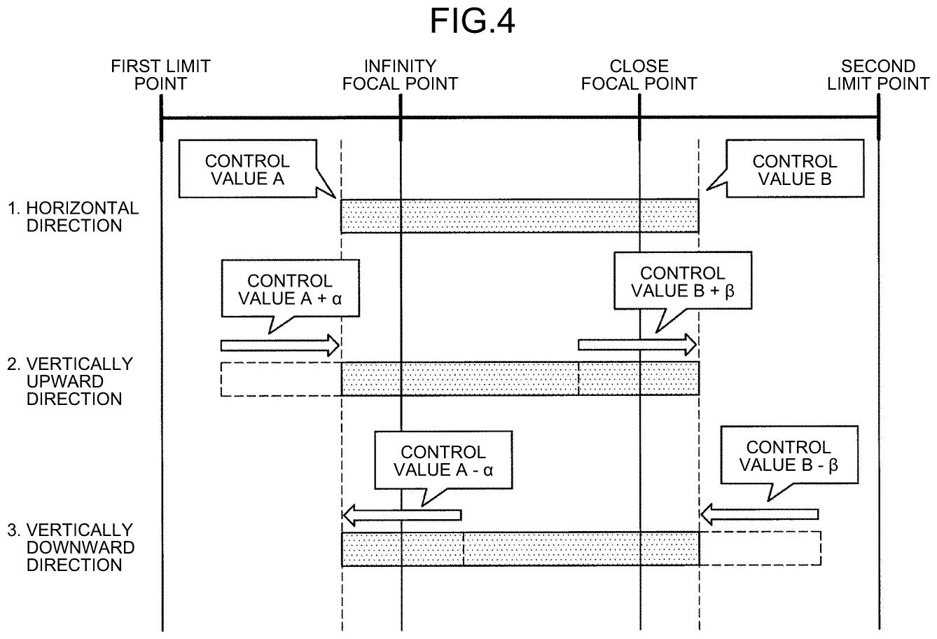

To describe the function of the present disclosure more specifically with reference to FIG. 4, the present disclosure calculates, on the basis of the posture information, a difference (postural difference) between the position of the optical member 130 in the first posture and the position of the optical member 130 when the imaging device 100 is oriented horizontally. Then, the present disclosure corrects the control value on the basis of the postural difference having been calculated, thereby controlling the drive of the optical member 130. For example, in the case where the imaging device 100 is oriented vertically upwards, as illustrated in “2. Vertically Upward Direction” of FIG. 4, the present disclosure corrects the control value “A” to “A+α” and corrects the control value “B” to “B+β”, thereby eliminating the postural difference. In addition, in the case where the imaging device 100 is oriented vertically downwards, as illustrated in “3. Vertically Downward Direction” of FIG. 4, the present disclosure corrects the control value “A” to “A−α” and corrects the control value “B” to “B−β”, thereby eliminating the postural difference. This allows the present disclosure to adjust the focus more appropriately in accordance with the posture of the imaging device 100 even if the posture of the imaging device 100 changes in various ways.

It is to be noted that the correction amounts “α” and “β” of the control values in FIG. 4 are merely examples, and can be appropriately changed depending on the situation. More specifically, the correction amounts of the control values respectively corresponding to the lower limit and the upper limit of the search range of the focal point may be identical or may be different. Of course, the correction amount of the control value is changed in accordance with the postural difference (accordingly, the absolute values of the correction amounts of the control values respectively corresponding to the lower limit and the upper limit of the search range of the focal point do not need to be the identical values of “α” and “β” in the case of the vertically upward direction and in the case of the vertically downward direction). Hereinafter, one embodiment of the present disclosure will be described in detail.

<2. Functional Configuration>

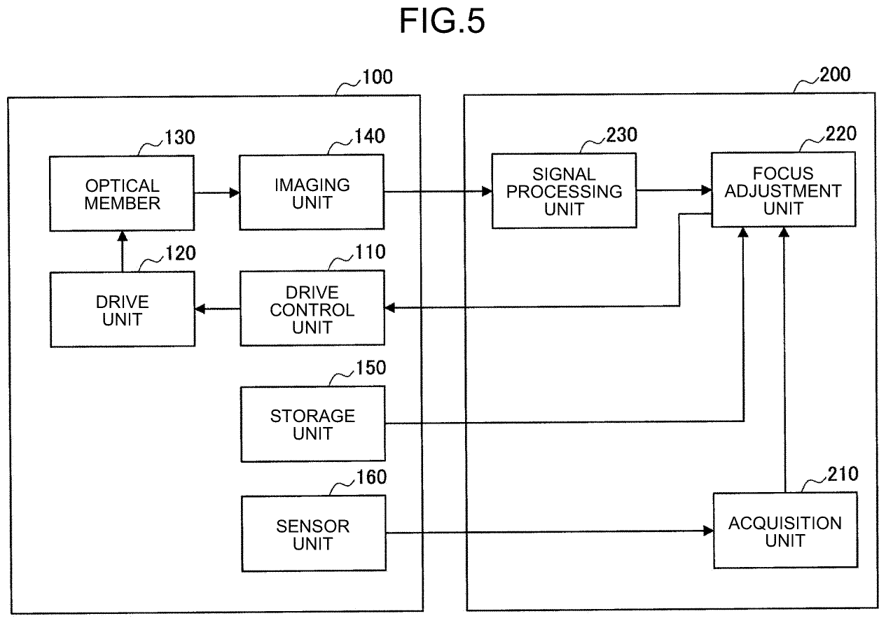

The outline according to one embodiment of the present disclosure has been described above. Subsequently, the configuration (mainly functional configuration) of each device according to the present embodiment will be described with reference to FIG. 5. FIG. 5 is a block diagram illustrating a configuration example of the imaging device 100 and a control device 200 according to the present embodiment. It is to be noted that FIG. 5 illustrates a main configuration example of the imaging device 100 and the control device 200 and a part of the configuration is omitted.

Here, the imaging device 100 is a device that generates an imaging signal by imaging a subject, and it is a camera mounted on a portable information processing device, for example. In addition, the control device 200 is a device that controls the imaging device 100, and it is an integrated circuit (IC) chip mounted on a portable information processing device, for example. It is to be noted that the types of the imaging device 100 and the control device 200 are not particularly limited. In addition, while FIG. 5 illustrates the imaging device 100 and the control device 200 as separate devices, the imaging device 100 and the control device 200 may be realized as a single device (e.g., the control device 200 may be provided within the imaging device 100).

(Functional Configuration of Imaging Device 100)

First, a functional configuration example of the imaging device 100 will be described. As illustrated in FIG. 5, the imaging device 100 includes a drive control unit 110, a drive unit 120, the optical member 130, an imaging unit 140, a storage unit 150, and a sensor unit 160.

The drive control unit 110 is configured to control the drive of the optical member 130 on the basis of control information generated for adjusting the focus on the basis of posture information that is information related to the first posture of the imaging device 100. More specifically, a focus adjustment unit 220 of the control device 200 described later generates control information for adjusting the focus of the imaging device 100 on the basis of the posture information which is information related to the first posture of the imaging device 100. Then, when the control information is provided from the focus adjustment unit 220, the drive control unit 110 controls the drive by the drive unit 120 on the basis of the control information, thereby controlling the drive of the optical member 130.

The drive unit 120 is configured to adjust the focus of the imaging device 100 by driving the focus lens included in the optical member 130 in the optical axis direction on the basis of the control information provided from the drive control unit 110. For example, the drive unit 120 may include an electromagnetic actuator (voice coil motor) in which a pair of magnets and a pair of coils drive a housing (lens barrel) that houses the optical member 130. It is to be noted that the configuration for driving the optical member 130 (particularly the focus lens) is not limited to a voice coil motor.

The optical member 130 is configured to take in light from the subject and to form an image of the light on the imaging unit 140 described later. The optical member 130 includes an optical element such as two or more lenses including a focus lens used for focus adjustment of the imaging device 100. It is to be noted that the number, arrangement, shape, or the like of each optical element included in the optical member 130 are not particularly limited.

The imaging unit 140 is configured to generate an imaging signal by light incident through the optical member 130. More specifically, the imaging unit 140 includes a solid-state imaging element array that detects light incident through the optical member 130 and generates an imaging signal by performing photoelectric conversion. The solid-state imaging element array is, for example, a charge coupled device (CCD) sensor array, a complementary metal oxide semiconductor (CMOS) sensor array, and the like, and not necessarily limited thereto. The imaging unit 140 provides the generated imaging signal to a signal processing unit 230 of the control device 200.

The storage unit 150 is configured to store various kinds of information. For example, the storage unit 150 stores postural difference information in advance. Details of the postural difference information will be described later. In addition, the storage unit 150 may store posture information acquired from the sensor unit 160, and may store programs, parameters, and the like used in each processing of the imaging device 100 and the control device 200. It is to be noted that the information stored in the storage unit 150 is not limited thereto.

The sensor unit 160 includes various sensors, and is configured to generate posture information, which is at least information related to the first posture of the imaging device 100. For example, the sensor unit 160 includes a gyro sensor, and generates posture information related to the first posture of the imaging device 100 by using the gyro sensor. It is to be noted that the type of the sensor included in the sensor unit 160 is not particularly limited. In addition, the sensor unit 160 may not necessarily be provided in the imaging device 100. More specifically, the sensor unit 160 may be included in the control device 200 or another external device (not illustrated) as long as it is capable of sensing the first posture of the imaging device 100. For example, in a case where the imaging device 100 and the control device 200 are fixed to each other, and the relative positional relationship between the imaging device 100 and the control device 200 does not change, the sensor unit 160 can sense the first posture of the imaging device 100 (i.e., the posture of the control device 200) even if included in the control device 200, and hence it is allowed to be included in the control device 200.

The functional configuration example of the imaging device 100 has been described above. It is to be noted that the functional configuration described above with reference to FIG. 5 is merely an example, and the functional configuration of the imaging device 100 is not limited to the example. For example, the imaging device 100 may include a functional configuration other than the functional configuration illustrated in FIG. 5, or may not necessarily include the entire functional configuration illustrated in FIG. 5. In addition, the functional configuration of the imaging device 100 can be flexibly modified in accordance with specifications and operations.

(Functional Configuration of Control Device 200)

Subsequently, a functional configuration example of the control device 200 will be described. As illustrated in FIG. 5, the control device 200 includes an acquisition unit 210, the focus adjustment unit 220, and the signal processing unit 230.

The acquisition unit 210 is configured to acquire posture information, which is information related to the first posture of the imaging device 100. More specifically, the acquisition unit 210 acquires the posture information generated by the sensor unit 160 of the imaging device 100. It is to be noted that the term “acquisition” includes not only processing in which the acquisition unit 210 acquires posture information via wired communication or wireless communication with the sensor unit 160 but also processing in which the acquisition unit 210 acquires posture information from a memory or the like (may be implemented by the storage unit 150 of the imaging device 100) in which the posture information is stored.

The focus adjustment unit 220 is configured to adjust the focus of the imaging device 100 by controlling the drive of the optical member 130 on the basis of the posture information and the postural difference information. Here, the “postural difference information” is information related to a difference (postural difference) between the position of the optical member 130 in the second posture as a reference and the position of the optical member 130 in a third posture different from the second posture. The “second posture as a reference” in the present embodiment is a posture in which the imaging device 100 is oriented substantially horizontally, and the “third posture” is a posture in which the imaging device 100 is oriented substantially vertically upwards or substantially vertically downwards. For example, in the manufacturing process of the imaging device 100, for the plurality of imaging devices 100 (plurality of samples), the postural difference is calculated by measuring the positions of the optical member 130 in the second posture (posture oriented substantially horizontally) and the third posture (posture oriented substantially vertically upwards or substantially vertically downwards). Then, information related to a representative value (e.g., mean value) based on the distribution of the postural differences about the plurality of imaging devices 100 is generated as postural difference information (i.e., the postural difference information is information obtained on the basis of the measurement results of the plurality of imaging devices 100). The postural difference information is stored in advance in the storage unit 150 of the imaging device 100 described above. It is to be noted that the postural difference information may be information measured for each of the individual imaging devices 100. For example, in the manufacturing process of the imaging device 100, the postural difference may be calculated for each of the individual imaging devices 100 by measuring the positions of the optical member 130 in the second posture (posture oriented substantially horizontally) and the third posture (posture oriented substantially vertically upwards or substantially vertically downwards).

When posture information is provided from the acquisition unit 210 at the time of focus adjustment of the imaging device 100, the focus adjustment unit 220 acquires postural difference information from the storage unit 150 of the imaging device 100, and calculates, on the basis of the posture information and the postural difference information, a difference (postural difference) between the position of the optical member 130 in the first posture (posture of the imaging device 100 at the time point when focus adjustment is performed) and the position of the optical member 130 in the second posture (posture oriented substantially horizontally). More specifically, the postural difference information is information related to the postural difference about the second posture (posture oriented substantially horizontally) and the third posture (posture oriented substantially vertically upwards or substantially vertically downwards) as described above, and the first posture is highly likely not to be substantially identical to the second posture or the third posture.

Here, if the postural difference about the second posture and the third posture is known, the postural difference about the posture between the second posture and the third posture (i.e., a posture oriented in the direction between the substantially horizontal direction and the substantially vertically upward direction or the substantially vertically downward direction) and the second posture can be calculated by a continuous function (e.g., linear function). Then, when the first posture is not substantially identical to the second posture or the third posture, the focus adjustment unit 220 calculates the postural difference about the first posture, which is a posture between the second posture and the third posture, and the second posture by solving the continuous function. Then, the focus adjustment unit 220 corrects the control value on the basis of the postural difference having been calculated.

In the case where the first posture (posture of the imaging device 100 at the time point when focus adjustment is performed) is substantially identical to the second posture (posture oriented substantially horizontally), the postural difference hardly occurs, and thus the focus adjustment unit 220 does not need to correct the control value. In addition, in the case where the first posture is substantially identical to the third posture (posture oriented substantially vertically upwards or substantially vertically downwards), the focus adjustment unit 220 may correct the control value by using as it is the postural difference included in the postural difference information. The focus adjustment unit 220 continues, until focus adjustment ends, the processing of generating control information including the corrected control value and providing the control information to the drive control unit 110 of the imaging device 100.

As described above, the postural difference information includes information related to the postural difference about the second posture and the third posture, and the focus adjustment unit 220 calculates the postural difference on the basis of the postural difference information, whereby the present disclosure can more appropriately correct the control value while reducing the amount of information to be stored in the storage unit 150 of the imaging device 100 described later, and hence the focus of the imaging device 100 can be adjusted more appropriately.

It is to be noted that the processing of the focus adjustment unit 220 and the postural difference information used in the processing are not necessarily limited to those described above. For example, the “second posture as a reference” related to the postural difference information does not necessarily have to be the posture in which the imaging device 100 is oriented substantially horizontally (i.e., it may be a posture in which the imaging device 100 is oriented in any direction). In addition, the “third posture” does not necessarily have to be the posture in which the imaging device 100 is oriented substantially vertically upward or substantially vertically downward (i.e., it may be a posture in which the imaging device 100 is oriented in any direction different from the second posture). In addition, the “third posture” may include respective postures when the imaging device 100 is oriented in a plurality of directions other than a substantially vertically upward direction or a substantially vertically downward direction. Due to this, the postural difference information includes information related to the postural difference about the second posture and the third posture that includes various postures, and thus the amount of information of the postural difference information to be stored in the storage unit 150 of the imaging device 100 increases. However, the focus adjustment unit 220 can more easily calculate the postural difference on the basis of the postural difference information. In addition, while the focus adjustment unit 220 is assumed to control the drive of the optical member 130 by the open loop control, it is not necessarily limited to this. More specifically, the focus adjustment unit 220 may control the drive of the optical member 130 by a so-called “closed loop control”, which is to judge, on the basis of feedback from a predetermined sensor or the like, whether or not the input has reached a predetermined target value.

Thereafter, the optical member 130 of the imaging device 100 is driven by using the control information generated by the focus adjustment unit 220, and when the contrast value about the imaging signal is acquired by the signal processing unit 230, the focus adjustment unit 220 searches a peak equal to or greater than a predetermined value about the contrast value. When detecting a peak equal to or greater than a predetermined value about the contrast value, the focus adjustment unit 220 moves the focus to a position where the peak was detected (i.e., the focus lens is driven to the position). This allows the focus adjustment unit 220 to appropriately adjust the focus of the imaging device 100.

The signal processing unit 230 is configured to perform various processing on the imaging signal generated by the imaging unit 140 of the imaging device 100. More specifically, the signal processing unit 230 performs, on the imaging signal, noise removal, gain adjustment, waveform shaping, A/D conversion, white balance adjustment, luminance adjustment, contrast value adjustment, sharpness (contour enhancement) adjustment, color correction, blur correction, and the like. In addition, when focus adjustment is performed, the signal processing unit 230 acquires the contrast value by performing predetermined signal processing using the imaging signal. The various processing realized by the signal processing unit 230 are not limited thereto.

The functional configuration example of the control device 200 has been described above. It is to be noted that the functional configuration described above with reference to FIG. 5 is merely an example, and the functional configuration of the control device 200 is not limited to the example. For example, the control device 200 may include a functional configuration other than the functional configuration illustrated in FIG. 5, or may not necessarily include the entire functional configuration illustrated in FIG. 5. In addition, the functional configuration of the control device 200 can be flexibly modified in accordance with specifications and operations.

<3. Flow of Processing>

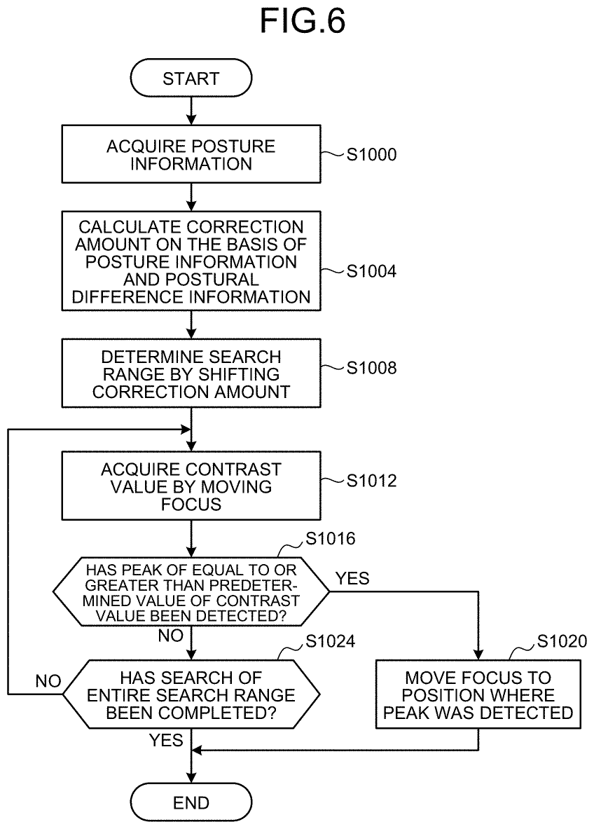

In the above, the configuration (mainly functional configuration) of each device according to the present embodiment has been described. Subsequently, with reference to FIG. 6, the flow of processing by each device according to the present embodiment will be described. FIG. 6 is a flowchart illustrating an example of the flow of processing related to autofocus by each device according to the present embodiment.

In Step S1000, the acquisition unit 210 of the control device 200 acquires posture information from the sensor unit 160 of the imaging device 100. In Step S1004, the focus adjustment unit 220 acquires postural difference information from the storage unit 150 of the imaging device 100, and calculates the correction amount of the control value on the basis of the posture information and the postural difference information. In Step S1008, the focus adjustment unit 220 determines the search range of the focal point by shifting the correction amount having been calculated.

In Step S1012, the drive control unit 110 of the imaging device 100 moves the focus by controlling the drive by the drive unit 120 on the basis of the control information provided from the control device 200, and the signal processing unit 230 of the control device 200 acquires the contrast value by performing predetermined signal processing. In Step S1016, the focus adjustment unit 220 searches a peak equal to or greater than a predetermined value about the contrast value by analyzing the contrast value provided from the signal processing unit 230. If a peak equal to or greater than the predetermined value about the contrast value is detected (Step S1016/Yes), the focus adjustment unit 220 moves in Step S1020 the focus to a position where the peak was detected (i.e., the focus lens is driven to the position), whereby the series of processing ends.

If a peak equal to or greater than a predetermined value about the contrast value is not detected (Step S1016/No), the focus adjustment unit 220 confirms in Step S1024 whether or not the search of the entire search range has been completed. If the search of the entire search range is not completed (Step S1024/No), the processing returns to Step S1012 (i.e., the processing on and after the move of the focus and the acquisition of the contrast value are performed again). If the search of the entire search range is completed (Step S1024/Yes), the series of processing ends. It is to be noted that if a peak equal to or greater than the predetermined value about the contrast value is not detected in the entire search range, the processing illustrated in FIG. 6 may be performed again, or other predetermined processing (e.g., implementation of an error notification to the operator) may be performed.

<4. First Variation>

In the above, the flow of processing by each device according to the present embodiment has been described. Subsequently, the first variation according to the present embodiment will be described.

In the first variation, the focus adjustment unit 220 of the control device 200 controls the drive of the optical member 130 also on the basis of limit point information related to the limit point of the range in which the optical member 130 can be driven. More specifically, the range in which the optical member 130 can be driven is physically limited by a stopper or the like. Then, as illustrated in FIGS. 1 to 4 above, of the limit points of the range in which the optical member 130 can be driven, the limit point in one direction (direction on the infinity focal point side) in which the optical member 130 can be driven is defined as the “first limit point” and the limit point in the direction (direction on the close focal point side) opposite to the one direction is defined as the “second limit point”. Then, the limit point information related to the first limit point and the second limit point is stored in advance in the storage unit 150 of the imaging device 100 according to the first variation.

Then, the focus adjustment unit 220 according to the first variation calculates the drive amount of the optical member 130 that does not exceed the range in which the optical member 130 can be driven on the basis of the first limit point and the second limit point, and controls the drive of the optical member 130 on the basis of the drive amount having been calculated. More specifically, when correcting the control value on the basis of the posture information and the postural difference information, the focus adjustment unit 220 judges, on the basis of the limit point information, whether or not the optical member 130 exceeds the limit point (either the first limit point or the second limit point) of the range in which the optical member 130 can be driven, depending on the corrected control value. Then, if the optical member 130 exceeds the limit point (either the first limit point or the second limit point) of the range in which the optical member 130 can be driven, the focus adjustment unit 220 further adjusts the correction amount of the control value, thereby preventing the optical member 130 from exceeding the limit point of the range in which the optical member 130 can be driven.

This allows the focus adjustment unit 220 to appropriately prevent the optical member 130 from coming into contact with the member at the first limit point or the second limit point, and hence it is possible to appropriately prevent contact noise from occurring (contact noise from being recorded if video recording is being performed) and each member from being damaged. In the case where the imaging device 100 is mounted on a small-sized device such as a portable information processing device, contact between members becomes highly likely to occur due to the demand for miniaturization, and hence the first variation is particularly useful when the imaging device 100 is mounted on a small-sized device. It is to be noted that in the search range of the focal point, the optical member 130 sometimes becomes incapable of moving as expected in a section from a certain point positioned before the limit point (the first limit point or the second limit point) to the limit point. For example, due to the influence of the elastic force of a spring provided in the drive unit 120 (not limited to this influence), deviation may occur in the position designated by the control value and the position to which the optical member 130 actually moves. Therefore, the focus adjustment unit 220 may control the drive of the optical member 130 also on the basis of the information related to the point at which the optical member 130 becomes incapable of moving as expected. More specifically, by further adjusting the correction amount of the control value, the focus adjustment unit 220 may control the drive of the optical member 130 so as not to exceed the point at which the optical member 130 becomes incapable of moving as expected. The functional configurations other than those of the focus adjustment unit 220 and the storage unit 150 can be the same as the functional configurations according to the embodiment described above, and hence the description thereof will be omitted.

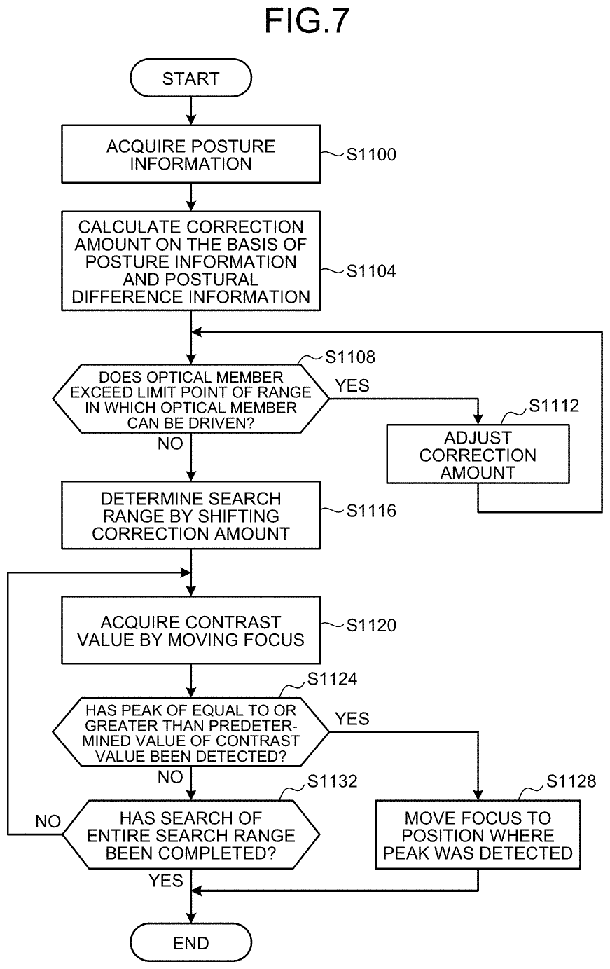

Subsequently, with reference to FIG. 7, the flow of processing by each device according to the first variation will be described. FIG. 7 is a flowchart illustrating a flow of processing related to autofocus by each device according to the first variation.

In Step S1100, the acquisition unit 210 of the control device 200 acquires posture information from the sensor unit 160 of the imaging device 100. In Step S1104, the focus adjustment unit 220 acquires postural difference information from the storage unit 150 of the imaging device 100, and calculates the correction amount of the control value on the basis of the posture information and the postural difference information.

In Step S1108, the focus adjustment unit 220 acquires the limit point information from the storage unit 150 of the imaging device 100, and judges, on the basis of the limit point information, whether or not the optical member 130 exceeds the limit point (either the first limit point or the second limit point) of the range in which the optical member 130 can be driven, depending on the corrected control value. If the optical member 130 exceeds the limit point of the range in which the optical member 130 can be driven (Step S1108/Yes), the focus adjustment unit 220 further adjusts, in Step S1112, the correction amount of the control value, thereby preventing the optical member 130 from exceeding the limit point of the range in which the optical member 130 can be driven.

If the correction amount of the control value is adjusted so that the optical member 130 does not exceed the limit point of the range in which the optical member 130 can be driven (Step S1108/No), the focus adjustment unit 220 determines, in Step S1116, the search range of the focal point by shifting the adjusted correction amount. The subsequent processing is the same as the processing of Steps S1012 to S1024 in FIG. 6 described above, and therefore the description thereof will be omitted.

<5. Second Variation>

In the above, the first variation according to the present embodiment has been described. Subsequently, the second variation according to the present embodiment will be described.

In the second variation, at least one of the postural difference information and the limit point information is information measured for each of the individual imaging devices 100. More specifically, for example, in the manufacturing process of the imaging device 100, the postural difference is output for each of the individual imaging devices 100 by measuring the positions of the optical member 130 in the second posture (posture oriented substantially horizontally) and the third posture (posture oriented substantially vertically upwards or substantially vertically downwards). In addition, for example, in the manufacturing process of the imaging device 100, the optical member 130 is actually driven, whereby the first limit point and the second limit point are measured for each of the individual imaging devices 100. Thereafter, the postural difference information and the limit point information that have been measured individually (alternatively, at least one of the postural difference information and the limit point information that have been measured individually) are stored in the storage unit 150 of the respective imaging devices 100. It is to be noted that the postural difference information or the limit point information may not be information measured for each of the individual imaging devices 100. For example, in the manufacturing process of the imaging device 100, for the plurality of imaging devices 100 (plurality of samples), the postural difference is calculated by measuring the positions of the optical member 130 in the second posture (posture oriented substantially horizontally) and the third posture (posture oriented substantially vertically upwards or substantially vertically downwards). In addition, for the plurality of imaging devices 100 (the plurality of samples), the optical member 130 is actually driven, whereby the limit point (the first limit point and the second limit point) is measured. Then, information related to respective representative values (e.g., mean values) based on the distribution of the postural differences and the limit points about the plurality of imaging devices 100 may be stored in the storage unit 150 as postural difference information and limit point information (i.e., the postural difference information or the limit point information may be information obtained on the basis of the measurement results of the plurality of imaging devices 100).

Here, the second variation can be applied to both the embodiment and the first variation that are described above. For example, when the second variation is applied to the embodiment described above, the control device 200 performs the processing illustrated in FIG. 6 using the postural difference information measured for each of the individual imaging devices 100. In addition, when the second variation is applied to the first variation described above, the control device 200 performs the processing illustrated in FIG. 7 using the postural difference information and the limit point information measured for each of the individual imaging devices 100 (alternatively, at least one of the postural difference information and the limit point information that have been measured individually).

The characteristics (e.g., mass and elastic force) of the optical member 130 and the drive unit 120 may vary considerably from one individual to another, and the control device 200 according to the second variation can appropriately adjust the focus responsive to the difference in the postural difference information and the limit point information due to the individual difference.

It is to be noted that the individual measurement of the postural difference information or the limit point information may not be performed in the manufacturing process of the imaging device 100. Such information may be updated as needed by separately providing the imaging device 100 or the control device 200 with a functional configuration capable of updating the postural difference information or the limit point information, for example. In addition, the characteristics of the optical member 130 and the drive unit 120 may change due to aging deterioration or the like. Therefore, the postural difference information or the limit point information may be information in which the aging change is taken into consideration. For example, the aging change of the postural difference information or the limit point information is predicted by a prior experiment or the like, whereby the focus adjustment unit 220 may recalculate the postural difference information or the limit point information after the aging change on the basis of the function indicating the aging change and the elapsed time from the time of manufacture. In addition, in the case of separately providing the imaging device 100 or the control device 200 with the functional configuration capable of updating the postural difference information or the limit point information, the functional configuration may update the postural difference information or the limit point information having changed over time.

<6. Hardware Configuration>

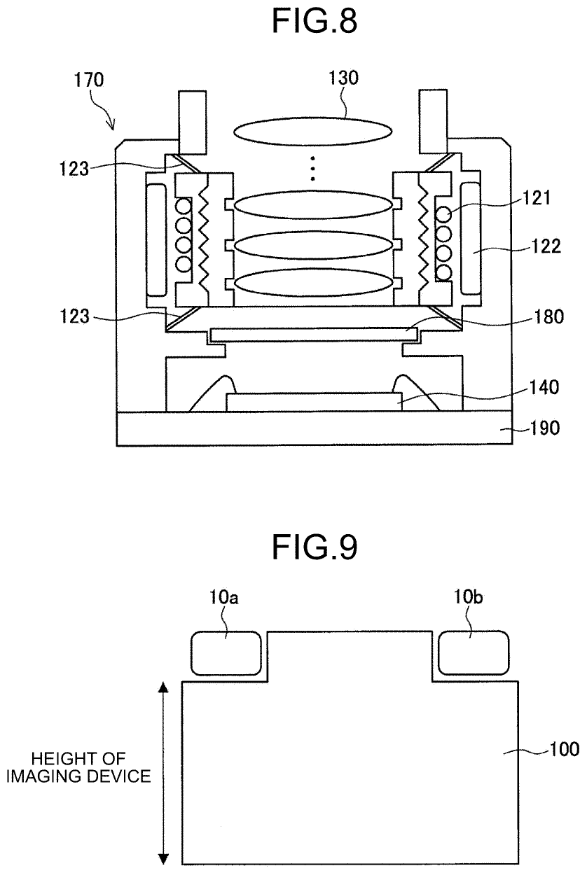

In the above, the second variation according to the present embodiment has been described. Subsequently, with reference to FIG. 8, the hardware configuration example of the imaging device 100 will be described. FIG. 8 is a view illustrating the outline of the hardware configuration example of the imaging device 100.

FIG. 8 illustrates a coil 121, a magnet 122, a spring 123, the optical member 130 (including a focus lens), the imaging unit 140 (including a solid-state imaging element array), a housing 170, an IR cut filter 180, and a substrate 190 that are included in the imaging device 100.

Of these, the coil 121, the magnet 122, and the spring 123 are configured to be provided when the drive unit 120 is a voice coil motor. The magnet 122 is configured to apply a magnetic field to the coils 121 arranged so as to face each other. The drive unit 120 applies a current to the coil 121 under the control of the drive control unit 110, whereby a Lorentz force is applied to the coil 121 by the magnetic field generated by the magnet 122. The orientation of the Lorentz force changes depending on the direction of the current flowing through the coil 121, and the magnitude of the force changes depending on the current amount. Then, the spring 123 elastically deforms by the Lorentz force, thereby changing the position of the optical member 130, and realizing focus adjustment.

The housing 170 is a member that involves each configuration of the imaging device 100 and has a predetermined shape. The IR cut filter 180 is configured to enhance color reproducibility by removing infrared light. It is to be noted that other than the IR cut filter 180, a low-pass filter for preventing the occurrence of moire may be provided in the preceding stage of the imaging unit 140. The substrate 190 is configured to include a circuit that realizes the drive control unit 110 and the like.

The hardware configuration example of the imaging device 100 has been described above. The control device 200 according to the present disclosure controls the drive of the optical member 130 on the basis of the posture information of the imaging device 100, whereby the miniaturization of the imaging device 100 can be realized while realizing autofocus by open loop control. More specifically, as illustrated in FIG. 9, the present disclosure makes it possible to shorten the height of the imaging device 100. This makes a space 10a and a space 10b larger, which enables other members to be arranged in the space 10a and the space 10b (enables the space 10a and the space 10b to be effectively utilized), and hence the miniaturization of the device becomes possible when the imaging device 100 and the control device 200 are stored in a certain device.

It is to be noted that the hardware configuration described above with reference to FIG. 8 is merely an example, and the hardware configuration of the imaging device 100 is not limited to the example. For example, the imaging device 100 may include a configuration other than the configuration illustrated in FIG. 8, or may not necessarily include the entire configuration illustrated in FIG. 8. In addition, the shape of the imaging device 100 described with reference to FIG. 9 is also merely an example, and the shape of the imaging device 100 is not limited to the example.

<7. Application to Information Processing Device 300>

In the above, the hardware configuration example of the imaging device 100 has been described. Subsequently, a case where the present disclosure is applied to the information processing device 300 will be described. More specifically, the imaging device 100 and the control device 200 described above can be stored in various information processing devices 300. Here, the type of the information processing device 300 is not particularly limited. For example, the information processing device 300 may be a portable information processing device such as a smartphone, a mobile phone, or a tablet personal computer (PC), but not necessarily limited thereto. For example, the information processing device 300 may be various devices that are not carried.

(7.1. Functional Configuration)

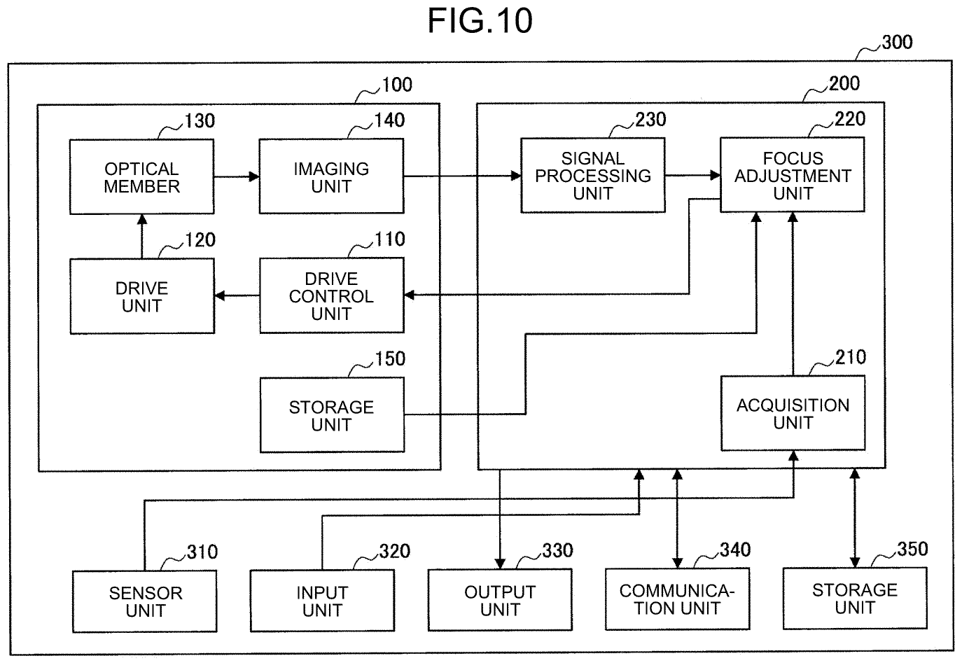

First, the functional configuration of the information processing device 300 will be described with reference to FIG. 10. FIG. 10 is a block diagram illustrating the functional configuration example of the information processing device 300. As illustrated in FIG. 10, the information processing device 300 includes the imaging device 100, the control device 200, a sensor unit 310, an input unit 320, an output unit 330, a communication unit 340, and a storage unit 350.

While the imaging device 100 may include the functional configuration described with reference to FIG. 5, it is not necessarily limited thereto and may not include a part of the functional configuration described with reference to FIG. 5. For example, in the embodiment illustrated in FIG. 10, the sensor unit 160 is provided outside the imaging device 100. The functional configuration other than that of the sensor unit 160 is the same as that described with reference to FIG. 5, and hence the description will be omitted.

While the control device 200 may also include the functional configuration described with reference to FIG. 5, it is not necessarily limited thereto and may not include a part of the functional configuration described with reference to FIG. 5. For example, in the embodiment illustrated in FIG. 10, the control device 200 includes the same functional configuration as the functional configuration described with reference to FIG. 5. It is to be noted that the acquisition unit 210 of the control device 200 acquires the posture information from the sensor unit 310 provided outside the imaging device 100.

The sensor unit 310 is configured to have the same function as that of the sensor unit 160 described with reference to FIG. 5. More specifically, the sensor unit 310 includes various sensors and is configured to sense at least the posture of the information processing device 300. Here, the imaging device 100 is fixed to the information processing device 300, and the relative positional relationship between the imaging device 100 and the information processing device 300 does not change. Accordingly, it should be noted that sensing the posture of the information processing device 300 by the sensor unit 310 is equivalent to sensing the posture of the imaging device 100 (i.e., generating posture information which is information related to the first posture of the imaging device 100). The sensor unit 310 includes, for example, a gyro sensor, and generates posture information related to the first posture of the imaging device 100 by using the gyro sensor. It is to be noted that the type of the sensor included in the sensor unit 310 is not particularly limited.

The input unit 320 is configured to receive various inputs by the operator. For example, the input unit 320 includes an input device such as a touch screen, a button, a switch, a mouse, a keyboard, or a microphone, and by using these input devices, the operator can perform input operations such as focus adjustment processing of the imaging device 100 and imaging processing by the imaging device 100. It is to be noted that the input devices included in the input unit 320 are not limited thereto.

The output unit 330 is configured to output various kinds of information. For example, the output unit 330 includes a display device such as a display, and, under the control of the control device 200, outputs an imaging signal or the like generated by the imaging device 100. In addition, the output unit 330 may include a voice output device such as a speaker, a tactile presentation device such as an actuator, or the like. It is to be noted that the output devices included in the output unit 330 are not limited thereto.

The communication unit 340 is configured to perform communication with an external device. For example, under the control of the control device 200, the communication unit 340 transmits various signals including an imaging signal to an external device or receives a response signal corresponding to the transmission signal from the external device. It is to be noted that the information to be communicated by the communication unit 340 and the case of communication are not particularly limited. In addition, the communication method by the communication unit 340 is also not particularly limited.

The storage unit 350 is configured to store various kinds of information. For example, the storage unit 350 stores an imaging signal generated by the imaging device 100 and the like, and stores programs, parameters, and the like used by each functional configuration of the information processing device 300. It is to be noted that the information stored in the storage unit 350 is not limited thereto.

The functional configuration example of the information processing device 300 has been described above. It is to be noted that the functional configuration described above with reference to FIG. 10 is merely an example, and the functional configuration of the information processing device 300 is not limited to the example. For example, the information processing device 300 may not necessarily include the entire functional configuration illustrated in FIG. 10. In addition, the functional configuration of the information processing device 300 can be flexibly modified in accordance with specifications and operations.

(7.2. Hardware Configuration)

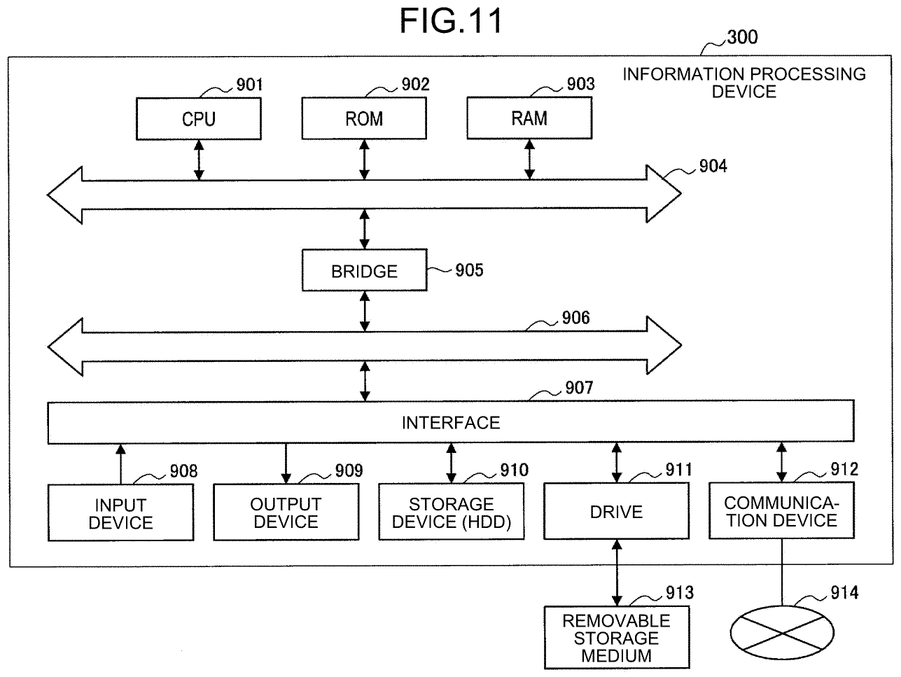

In the above, the functional configuration of the information processing device 300 has been described. Subsequently, with reference to FIG. 11, the hardware configuration of the information processing device 300 will be described. FIG. 11 is a diagram illustrating a hardware configuration example of the information processing device 300. It is to be noted that the control device 200 alone described above may include a hardware configuration example illustrated in FIG. 11.

The information processing device 300 includes a central processing unit (CPU) 901, a read only memory (ROM) 902, a random access memory (RAM) 903, a host bus 904, a bridge 905, an external bus 906, an interface 907, an input device 908, an output device 909, a storage device (HDD) 910, a drive 911, and a communication device 912.

The CPU 901 functions as an arithmetic processing device and controls the overall operation of the information processing device 300 in accordance with various programs. In addition, the CPU 901 may be a microprocessor. The ROM 902 stores programs and operation parameters used by the CPU 901. The RAM 903 temporarily stores programs to be used in execution of the CPU 901 and parameters which change appropriately in the execution. These are interconnected by the host bus 904 composed of a CPU bus and the like. Cooperation among the CPU 901, the ROM 902, and the RAM 903 realizes a part of the functions of the control device 200 or the imaging device 100, which are included in the information processing device 300.

The host bus 904 is connected to the external bus 906 such as a peripheral component interconnect/interface (PCI) bus via the bridge 905. It is to be noted that the host bus 904, the bridge 905, and the external bus 906 do not necessarily need to be separately configured, and these functions may be implemented on one bus.

The input device 908 includes input means for the operator to input information such as a mouse, a keyboard, a touch screen, a button, a microphone, a switch, a lever, or a camera, and an input control circuit that generates an input signal on the basis of the input by the operator and outputs the input signal to the CPU 901. By operating the input device 908, the operator of the information processing device 300 can input various kinds of information to each device and instruct a processing operation to each device. The input device 908 realizes the functions of the sensor unit 310, the input unit 320, or the imaging device 100.

The output device 909 includes a display device such as a cathode ray tube (CRT) display device, a liquid crystal display (LCD) device, an organic light emitting diode (OLED) device, and a lamp. In addition, the output device 909 includes a voice output device such as a speaker and a headphone. The display device displays various kinds of information such as an imaging signal. On the other hand, the voice output device converts voice information or the like into voice and outputs it. The output device 909 realizes the function of the output unit 330.

The storage device 910 is a device for storing data. The storage device 910 may include a storage medium, a recording device that records data onto the storage medium, a reading device that reads data from the storage medium, and a deleting device that deletes data recorded on the storage medium. The storage device 910 is composed of, for example, a hard disk drive (HDD). The storage device 910 drives a hard disk and stores programs executed by the CPU 901 and various data. The storage device 910 realizes the function of the storage unit 350.

The drive 911 is a reader/writer for storage medium, and is built in or externally attached to the information processing device 300. The drive 911 reads information recorded on a removable storage medium 913 such as a magnetic disk, an optical disk, a magneto-optical disk, or a semiconductor memory that are attached, and outputs the information to the RAM 903. In addition, the drive 911 can also write information into the removable storage medium 913.

The communication device 912 is a communication interface including a communication device for connecting to a communication network 914, for example. The communication device 912 realizes the function of the communication unit 340.

<8. Summary>

As described above, the control device 200 according to the present disclosure adjusts the focus of the imaging device 100 by acquiring posture information which is information related to the first posture (posture of the imaging device 100 at the time point when focus adjustment is performed) of the imaging device 100 and controlling the drive of the optical member 130 on the basis of the posture information. More specifically, at the time of focus adjustment, the focus adjustment unit 220 of the control device 200 acquires postural difference information from the storage unit 150, and calculates, on the basis of the posture information and the postural difference information, a difference (postural difference) between the position of the optical member 130 in the first posture and the position of the optical member 130 in the second posture (posture oriented substantially horizontally). Then, the focus adjustment unit 220 corrects the control value on the basis of the postural difference having been calculated. This allows the focus adjustment unit 220 to adjust the focus more appropriately in accordance with the posture of the imaging device 100 even if the posture of the imaging device 100 changes in various ways.

Regarding the first variation, the focus adjustment unit 220 controls the drive of the optical member 130 also on the basis of limit point information related to the limit point of the range in which the optical member 130 can be driven. This allows the focus adjustment unit 220 to appropriately prevent the optical member 130 from coming into contact with the member at the first limit point or the second limit point, and hence it is possible to appropriately prevent contact noise from occurring (contact noise from being recorded if video recording is being performed) and each member from being damaged.

In addition, regarding the second variation, information measured for each of the individual imaging devices 100 can be used for at least one of the postural difference information and the limit point information. The characteristics (e.g., mass and elastic force) of the optical member 130 (e.g., a focus lens) and the drive unit 120 (e.g., an electromagnetic actuator) may vary considerably from one individual to another, and the focus adjustment unit 220 according to the second variation can appropriately adjust the focus responsive to the difference in the postural difference information and the limit point information due to the individual difference.

While the preferred embodiments of the present disclosure have been described in detail with reference to the accompanying drawings, the technical scope of the present disclosure is not limited to such examples. It is obvious that a person having ordinary knowledge in the technical field of the present disclosure can conceive of various variations or modifications within the scope of the technical ideas set forth in the claims, which are also naturally understood to fall within the technical scope of the present disclosure.

In addition, the effects described in the present description are merely illustrative or exemplary and not limiting. That is, the technique according to the present disclosure can achieve other effects apparent to those skilled in the art from the description herein in addition to or in place of the above effects.

The following configuration also falls within the technical scope of the present disclosure.

(1)

A control device, comprising:

an acquisition unit that acquires posture information that is information related to a first posture of an imaging device; and

a focus adjustment unit that adjusts a focus of the imaging device by controlling drive of an optical member on a basis of the posture information.

(2)

The control device according to (1), wherein

the focus adjustment unit controls drive of the optical member by open loop control.

(3)

The control device according to (2), wherein

the focus adjustment unit controls drive of the optical member also on a basis of postural difference information that is information related to a difference between a position of the optical member in a second posture as a reference and a position of the optical member in a third posture different from the second posture.

(4)

The control device according to (3), wherein

the second posture is a posture in which the imaging device is oriented substantially horizontally, and

the third posture is a posture in which the imaging device is oriented substantially vertically upwards or substantially vertically downwards.

(5)

The control device according to (3) or (4), wherein

the focus adjustment unit calculates a difference between a position of the optical member in the first posture and a position of the optical member in the second posture on a basis of the posture information and the postural difference information, and controls drive of the optical member on a basis of the difference having been calculated.

(6)

The control device according to any one of (3) to (5), wherein

the postural difference information is information measured for each of the individual imaging devices or information obtained on a basis of measurement results for a plurality of the imaging devices.

(7)

The control device according to any one of (2) to (6), wherein

the focus adjustment unit controls drive of the optical member also on a basis of limit point information that is information related to a limit point of a range in which the optical member can be driven.

(8)

The control device according to (7), wherein

the limit point includes a first limit point in one direction in which the optical member can be driven and a second limit point in a direction opposite to the one direction.

(9)

The control device according to (8), wherein

the focus adjustment unit calculates a drive amount of the optical member not exceeding a range in which the optical member can be driven on a basis of the first limit point and the second limit point, and controls drive of the optical member on a basis of the drive amount having been calculated.

(10)

The control device according to any one of (7) to (9), wherein

the limit point information is information measured for each of the individual imaging devices or information obtained on a basis of measurement results for a plurality of the imaging devices.

(11)

An imaging device, comprising:

an optical member that takes in light from a subject;

an imaging unit that generates an imaging signal by light incident through the optical member; and

a drive control unit that controls drive of the optical member on a basis of control information generated for adjusting a focus on a basis of posture information that is information related to a first posture of an imaging device.

(12)

An information processing device, comprising:

a control device and an imaging device, wherein

the control device includes:

an acquisition unit that acquires posture information that is information related to a first posture of the imaging device, and

a focus adjustment unit that adjusts a focus of the imaging device by generating control information that controls drive of an optical member on a basis of the posture information, and

the imaging device includes:

the optical member that takes in light from a subject,

an imaging unit that generates an imaging signal by light incident through the optical member, and

a drive control unit that controls drive of the optical member on a basis of the control information.

(13)

A control method executed by a computer, comprising:

acquiring posture information that is information related to a first posture of an imaging device; and

adjusting a focus of the imaging device by controlling drive of an optical member on a basis of the posture information.

### REFERENCE SIGNS LIST

100 IMAGING DEVICE
110 DRIVE CONTROL UNIT
120 DRIVE UNIT
130 OPTICAL MEMBER
140 IMAGING UNIT
150 STORAGE UNIT
160 SENSOR UNIT
200 CONTROL DEVICE
210 ACQUISITION UNIT
220 FOCUS ADJUSTMENT UNIT
230 SIGNAL PROCESSING UNIT
300 INFORMATION PROCESSING DEVICE
310 SENSOR UNIT
320 INPUT UNIT
330 OUTPUT UNIT
340 COMMUNICATION UNIT
350 STORAGE UNIT

1. A control device, comprising:
an acquisition unit that acquires posture information that is information related to a first posture of an imaging device; and
a focus adjustment unit that adjusts a focus of the imaging device by controlling drive of an optical member on a basis of the posture information.

2. The control device according to claim 1, wherein
the focus adjustment unit controls drive of the optical member by open loop control.

3. The control device according to claim 2, wherein
the focus adjustment unit controls drive of the optical member also on a basis of postural difference information that is information related to a difference between a position of the optical member in a second posture as a reference and a position of the optical member in a third posture different from the second posture.

4. The control device according to claim 3, wherein
the second posture is a posture in which the imaging device is oriented substantially horizontally, and
the third posture is a posture in which the imaging device is oriented substantially vertically upwards or substantially vertically downwards.

5. The control device according to claim 3, wherein
the focus adjustment unit calculates a difference between a position of the optical member in the first posture and a position of the optical member in the second posture on a basis of the posture information and the postural difference information, and controls drive of the optical member on a basis of the difference having been calculated.

6. The control device according to claim 3, wherein
the postural difference information is information measured for each of the individual imaging devices or information obtained on a basis of measurement results for a plurality of the imaging devices.

7. The control device according to claim 2, wherein
the focus adjustment unit controls drive of the optical member also on a basis of limit point information that is information related to a limit point of a range in which the optical member can be driven.

8. The control device according to claim 7, wherein
the limit point includes a first limit point in one direction in which the optical member can be driven and a second limit point in a direction opposite to the one direction.

9. The control device according to claim 8, wherein
the focus adjustment unit calculates a drive amount of the optical member not exceeding a range in which the optical member can be driven on a basis of the first limit point and the second limit point, and controls drive of the optical member on a basis of the drive amount having been calculated.

10. The control device according to claim 7, wherein
the limit point information is information measured for each of the individual imaging devices or information obtained on a basis of measurement results for a plurality of the imaging devices.

11. An imaging device, comprising:
an optical member that takes in light from a subject;
an imaging unit that generates an imaging signal by light incident through the optical member; and
a drive control unit that controls drive of the optical member on a basis of control information generated for adjusting a focus on a basis of posture information that is information related to a first posture of an imaging device.

12. An information processing device, comprising:
a control device and an imaging device, wherein
the control device includes:
an acquisition unit that acquires posture information that is information related to a first posture of the imaging device, and
a focus adjustment unit that adjusts a focus of the imaging device by generating control information that controls drive of an optical member on a basis of the posture information, and
the imaging device includes:
the optical member that takes in light from a subject,
an imaging unit that generates an imaging signal by light incident through the optical member, and
a drive control unit that controls drive of the optical member on a basis of the control information.

13. A control method executed by a computer, comprising:
acquiring posture information that is information related to a first posture of an imaging device; and
adjusting a focus of the imaging device by controlling drive of an optical member on a basis of the posture information.
